(19) United States
(12) Patent Application Publication
(10) Pub. No.: US 2025/0292792 A1
(43) Pub. Date: Sep. 18, 2025

(54) HARD DISK DRIVE SUSPENSION FINE ACTUATOR WITH MINIATURIZED SINGLE-LAYER PIEZOELECTRIC ELEMENTS

(71) Applicant: Western Digital Technologies, Inc., San Jose, CA (US)

(72) Inventors: Yanning Liu, San Jose, CA (US); Kia Moh Teo, San Jose, CA (US); Tzong-Shii Pan, Santa Clara, CA (US)

(21) Appl. No.: 19/221,385

(22) Filed: May 28, 2025

(51) Int. Cl. G11B 5/48

(52) U.S. Cl. CPC G11B 5/483; G11B 5/4833; G11B 5/4873

(57) ABSTRACT

A hard disk drive (HDD) suspension assembly includes a microactuator mechanically configured to directly move a flexure tongue to move a slider mounted thereto. The microactuator includes single-layer piezoelectric elements recessed in metal-layer pockets in the flexure tongue, with each piezoelectric element having continuous top and bottom electrodes spanning the length. A non-conductive adhesive attaching the piezoelectric element is positioned to insulate the top and bottom electrodes and to fill a gap between the piezoelectric element and the metal layer for piezoelectric-to-flexure tongue load transfer effectiveness. The piezoelectric element is electrically connected via an electrically-conductive adhesive that may be configured to bridge a gap separating the mounting pocket and a separate opening to the conductive layer. The piezoelectric driving signal can be simplified absent direct current bias for depolarization concerns.

### FIELD OF EMBODIMENTS

Embodiments of the invention may relate generally to a hard disk drive and particularly to a fine actuator having single-layer piezoelectric elements.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write head (or “transducer”) that is positioned over a specific location of a disk by an actuator. A read-write head makes use of magnetic fields to write data to and read data from the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium.

An HDD includes at least one head gimbal assembly (HGA) that generally includes a suspension assembly and a corresponding head slider (or simply “slider”) mounted thereon and which houses the read/write transducer (or “head”). Each slider is attached to the free end of the suspension assembly that is cantilevered from the rigid arm of an actuator. Several actuator arms may be combined to form a single movable unit, a head stack assembly (HSA), typically having a rotary pivotal bearing system. The suspension assembly of a conventional HDD typically includes a relatively stiff load beam with a mount plate at its base end, which attaches to the actuator arm, and whose free end mounts a flexure (or “gimbal” or “gimbal flexure”) that carries the slider and its read-write head. It is the function of the flexure to provide gimbaled support for the slider so that the slider can pitch and roll (i.e., can gimbal) in order to adjust its orientation.

Increasing areal density, i.e., a measure of the quantity of information bits that can be stored on a given area of disk surface (often characterized in terms of tracks-per-inch or TPI), has led to the necessary development and implementation of secondary and even tertiary actuators (generally, “fine actuators”) for improved head positioning through relatively fine positioning, in addition to a primary voice coil motor (e.g., VCM) actuator which provides relatively coarse positioning. Some HDDs employ milli-or micro-actuator designs to provide second and/or third stage actuation of the read-write head to enable more accurate positioning of the head relative to the recording tracks. Milli-actuators (or “milliactuators”) may be broadly classified as actuators that move the entire front end of the suspension (e.g., load beam, flexure, and slider) and are typically used as second stage actuators. Micro-actuators (or “microactuators”) may be broadly classified as actuators that move (e.g., rotate) only the slider, moving it relative to the suspension and load beam, or move only the read-write element relative to the slider body. A microactuator may be used solely in conjunction with a first stage actuator (e.g., VCM), or in conjunction with a first stage actuator and a second stage actuator (e.g., milliactuator) for more accurate head positioning. Unless otherwise indicated, the terms “micro-actuator”, “milli-actuator”, “secondary actuator”, “tertiary actuator”, “dual stage actuator”, “fine actuator” and the like, if used herein, refer generally to a relatively fine-positioning actuator (e.g., technically, either secondary or tertiary) used in conjunction with a primary relatively coarse-positioning actuator, such as a VCM actuator in the context of an HDD. Piezoelectric based and capacitive micro-machined transducers are two types of fine actuators that have been developed for use with HDD sliders.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment;

FIG. 2 is a perspective view illustrating an actuator assembly;

FIG. 3 is a perspective view illustrating a head gimbal assembly;

FIG. 4 is a perspective view illustrating a suspension microactuator assembly with 3-layer piezoelectric elements, including a cross-section of a piezoelectric element and installation;

FIG. 5A is a side cross-sectional diagram illustrating a 3-layer piezoelectric element of conventional length;

FIG. 5B is a side cross-sectional diagram illustrating a 3-layer piezoelectric element of reduced length, according to an embodiment;

FIG. 6A is a perspective view illustrating a suspension microactuator assembly with single-layer piezoelectric elements, including a cross-section of a piezoelectric element and installation, according to an embodiment;

FIG. 6B is a cross-sectional side view illustrating the suspension microactuator assembly with single-layer piezoelectric elements of FIG. 6A, according to an embodiment;

FIG. 7 includes top and cross-sectional side views illustrating installation of a 3-layer piezoelectric element onto a suspension flexure;

FIG. 8A includes top and cross-sectional side views illustrating installation of a single-layer piezoelectric element onto a suspension flexure, according to an embodiment;

FIG. 8B includes top and cross-sectional side views illustrating installation of a single-layer piezoelectric element onto a suspension flexure, according to an embodiment;

FIG. 9A is an exploded perspective view illustrating a suspension milliactuator assembly with single-layer piezoelectric elements;

FIG. 9B is a top view illustrating installation of the milliactuator assembly of FIG. 9A;

FIG. 9C is a bottom view illustrating the installation of the milliactuator assembly of FIG. 9A; and

FIG. 10 is a flow diagram illustrating a method of manufacturing a HDD microactuator system, according to an embodiment.

### DETAILED DESCRIPTION

Generally, approaches to a single-layer piezoelectric fine actuator element for a suspension assembly of a head-gimbal assembly (HGA) for a hard disk drive (HDD) are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### Introduction

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment or to every embodiment.

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the structure is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

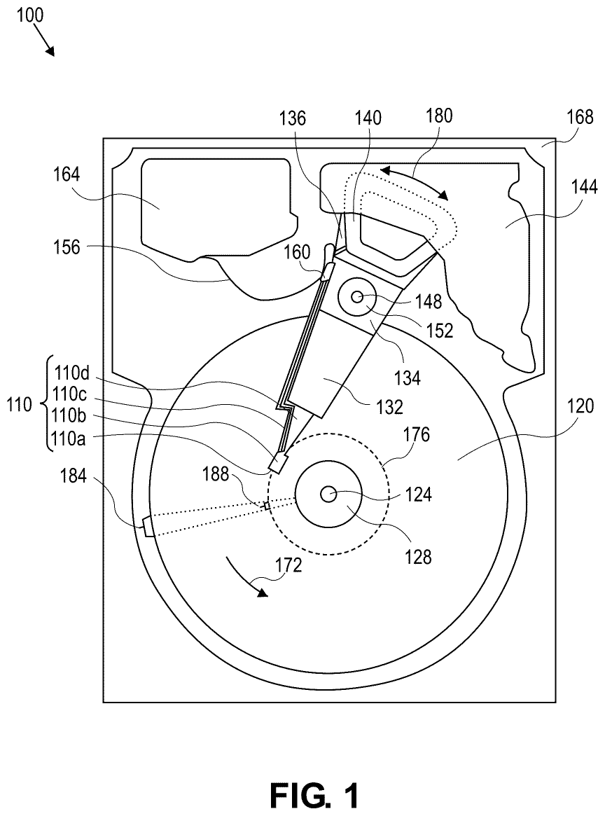

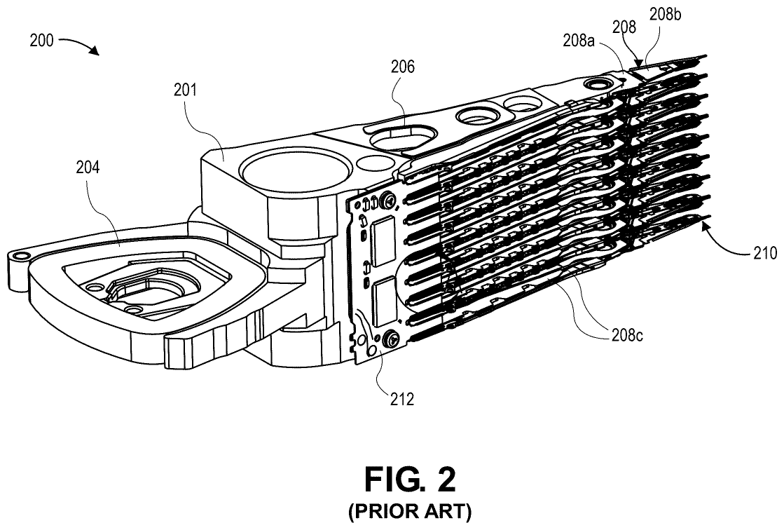

FIG. 2 is a perspective view illustrating an actuator assembly, according to an embodiment. Actuator assembly 200 comprises a carriage 201 (see, e.g., carriage 134 of FIG. 1) rotatably coupled with a central pivot shaft (not shown here; see, e.g., pivot shaft 148 of FIG. 1) by way of a pivot bearing assembly (not shown here; see, e.g., pivot bearing assembly 152 of FIG. 1), and rotationally driven by a voice coil motor (VCM), of which a voice coil 204 is illustrated here. Actuator assembly 200 further comprises multiple actuator arms 206 (see, e.g., arm 132 of FIG. 1), to each of which is coupled a suspension assembly 208 (see, e.g., lead suspension 110c of FIG. 1) housing a read-write head 210 (see, e.g., read-write head 110a of FIG. 1), and typically comprising a swaged baseplate 208a, a load beam 208b (see, e.g., load beam 110d of FIG. 1), and a suspension tail 208c. Each suspension assembly 208 is electrically connected with a flexible printed circuit (FPC) 212 coupled with the carriage 201, by way of suspension tail 208c.

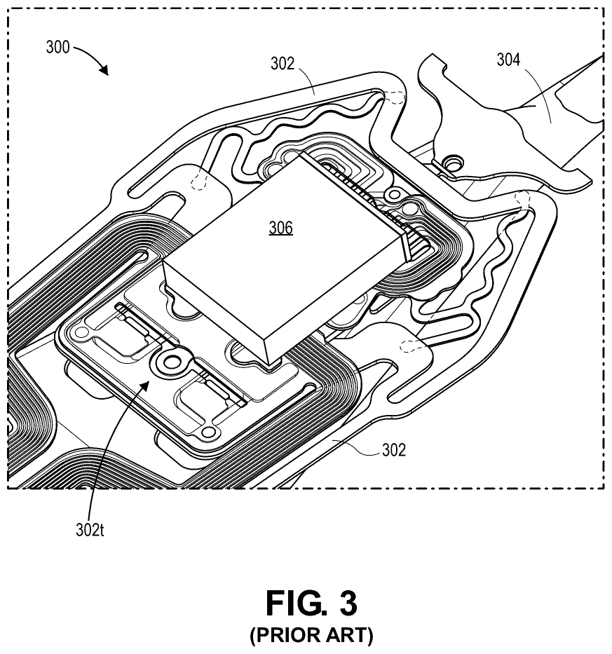

FIG. 3 is a perspective view illustrating a head gimbal assembly. Head gimbal assembly (HGA) 300 includes a flexure 302 movably coupled with a load beam 304. The HGA 300, particularly the flexure 302, includes a tongue 302t area on which a slider 306 is mounted, as well as possibly a set of microactuator piezoelectric (such as PZT (lead zirconate titanate)) elements (not visible, on underside if present) and associated features.

### Fine Actuator Usage in Hard Disk Drives

Recall that fine actuators were developed and implemented for hard disk drives (HDDs) for improved head positioning through relatively fine positioning, in conjunction with a primary voice coil motor (e.g., VCM) actuator which provides relatively coarse positioning. Furthermore, piezoelectric-based transducers are a type of fine actuator commonly used with HDD sliders.

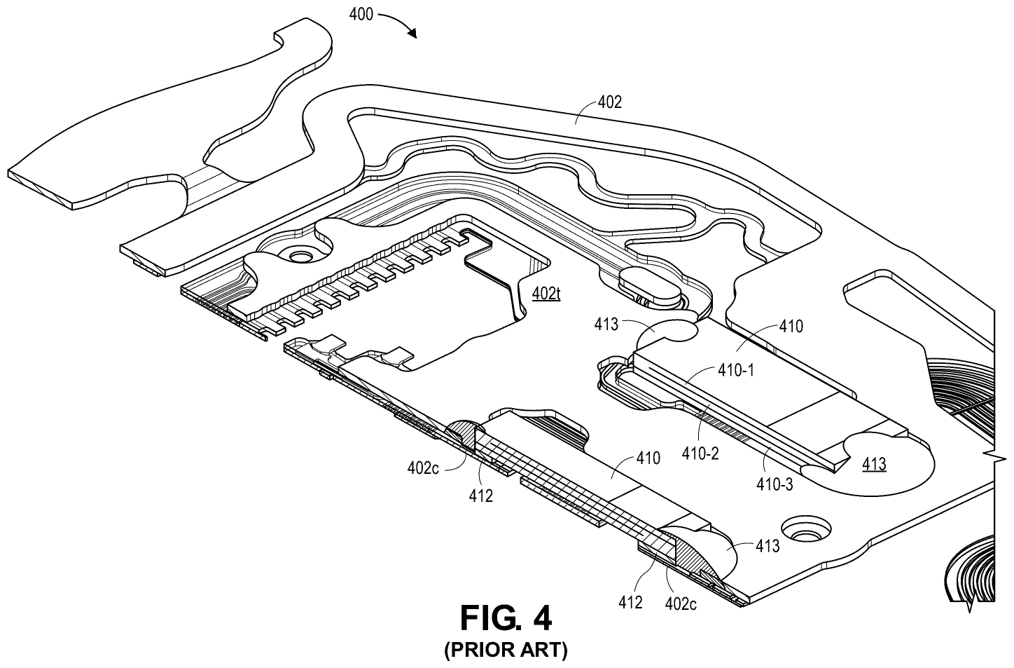

FIG. 4 is a perspective view illustrating a suspension microactuator assembly with 3-layer piezoelectric elements, including a cross-section of a piezoelectric element and installation. Suspension assembly 400 includes a flexure 402 movably coupled with a load beam (not shown here; see, e.g., load beam 110d of FIG. 1, load beam 208b of FIG. 2, load beam 304 of FIG. 3). The suspension assembly 400, particularly the flexure 402, includes a tongue 402t area on which a slider (not shown here; see, e.g., slider 110b of FIG. 1, slider 306 of FIG. 3) is mounted. Suspension assembly 400 further includes a set (e.g., two, as shown here) of microactuator piezoelectric elements 410 and associated features. Here, each piezoelectric element 410 is a 3-layer piezoelectric element including piezoelectric layer 410-1, piezoelectric layer 410-2, and piezoelectric layer 410-3. Each piezoelectric element 410 is attached at each end to the flexure tongue 402t via a non-conductive adhesive (NCA) 413 for structural integrity, which is optional. Each piezoelectric element 410 is attached at the bottom surface at each end to a flexure conductive layer/circuit 402c via electrically conductive adhesive (ECA) 412. One approach to an in-tongue microactuator piezoelectric can be found in U.S. Pat. No. 8,085,508 entitled “System, Method and Apparatus for Flexure-Integrated Microactuator”.

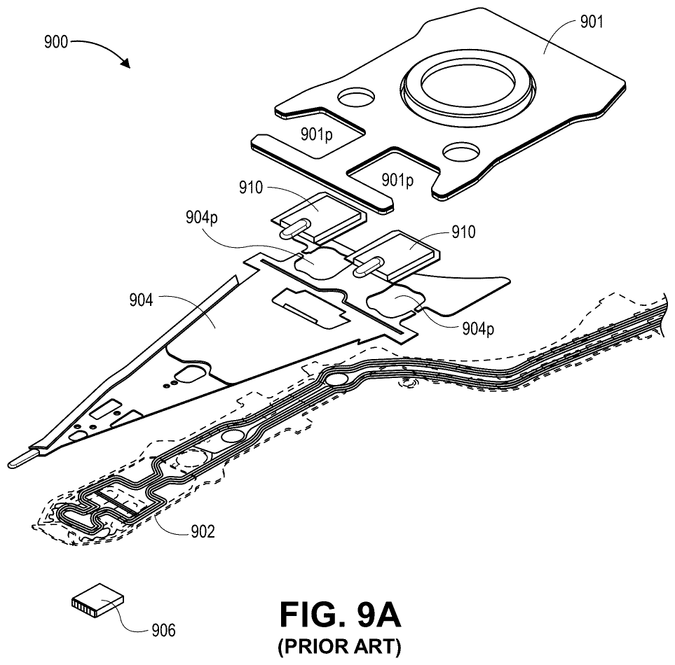

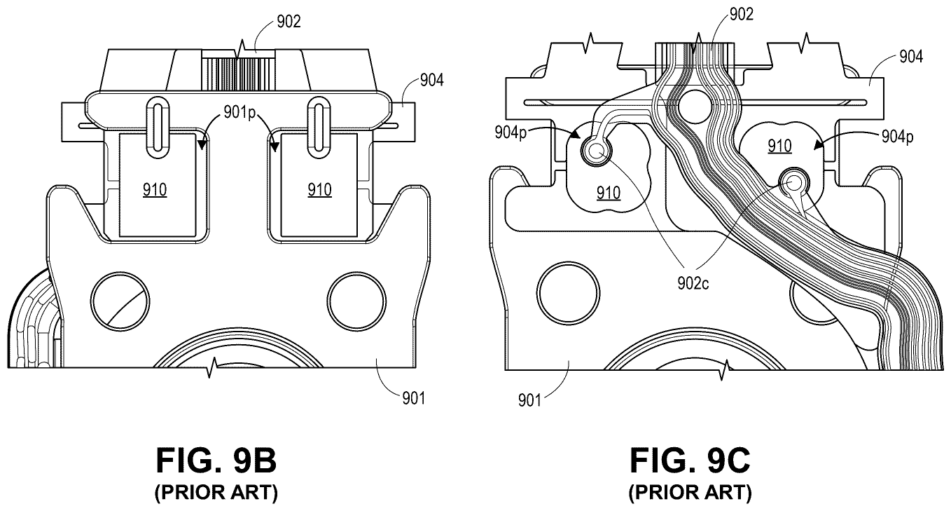

Positioning the piezoelectric elements near the read-write head/slider (“collocated design”) is generally better for actuator dynamics, which is critical for the actuator off-track control capability. On the other hand, more expensive multiple-layer piezoelectric (“multi-layer piezoelectric”) elements are typically used to provide enough actuator motion (stroke) because collocated designs typically do not have enough space for geometry amplification, compared to non-collocated designs where the piezoelectric elements are placed away from the head/slider (see, e.g., milliactuator system 900 of FIG. 9A). A multi-layer piezoelectric is capable of generating more stroke because the electrical field (“E field”) in each layer is higher (E field is volt over thickness) when control voltage range is limited. However, a higher E field in a piezoelectric, against the poling direction, can depolarize the piezoelectric and lead to actuation failure. Thus, to prevent this failure, a circuit driver with a constant or DC (direct current) voltage bias along the piezoelectric poling direction is often deployed along with the AC (alternating current) voltage application, which costs more compared to an AC driver without DC bias.

The microactuator (“μAct”) frequency response function (FRF) is one critical factor in determining its TPI capability, such as by improving the track misregistration (TMR) capability. Here, TMR generally refers to where a track-following/servoing head is relative to where it is supposed to be, i.e., the variance of the deviation of the read-write head from the center of a data track. Designing a μAct mechanism to create an FRF approaching that of an ideal actuator is a field of constant innovation, hence it is noteworthy that the performance of an ideal actuator is determined by its natural frequency. Simply stated, a higher natural frequency corresponds to a better actuator. An actual μAct design on a continuous structure, however, has many structure modes below its corresponding “system mode” that corresponds to the yaw motion of the slider. The piezoelectric elements, considered the most important design features of a μAct, contribute to both stiffness and mass of the actuator system. The piezoelectric length is considered an effective dimension to change the natural frequency as it has opposite effects on the corresponding stiffness and mass. More specifically, reducing the piezoelectric length (e.g., with all other dimensions being held constant) reduces its mass and increases its effective stiffness, both of which can boost the μAct system mode frequency. Therefore, in furtherance of a better-performing fine actuator, and thus a higher-TPI HDD, reducing the length of the piezoelectric element(s) (e.g., while attempting to maintain other performance parameters such as μAct total stroke) may be desirable.

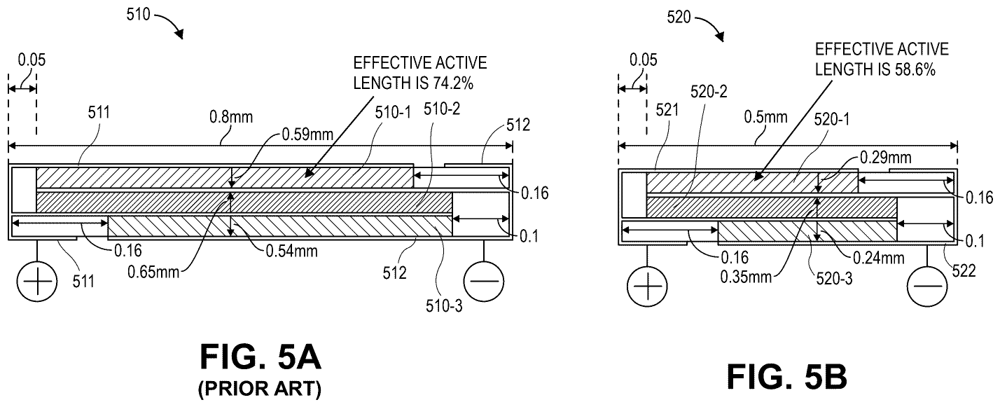

However, there are challenges to overcome with respect to reducing the length of a 3-layer piezoelectric element, for example. FIG. 5A is a side cross-sectional diagram illustrating a 3-layer piezoelectric element of conventional length. FIG. 5A presents a manufacturing constraint or limitation associated with multiple-layer piezoelectric elements, namely, so-called “dead zones”. A 3-layer piezoelectric element 510 is depicted, with layer 510-1 having polarity in down direction, layer 510-2 having polarity in up direction, and layer 510-3 having polarity in down direction, each respectively depicted with arrows. piezoelectric element 510 further comprises a positive top electrode 511 extending from the top surface of piezoelectric element 510 and wrapping around the end (left side) to the top surface of layer 510-3 and the left end of the bottom surface of piezoelectric element 510. Likewise, a negative bottom electrode 512 extends from the bottom surface of piezoelectric element 510 and wraps around the end (right side) to the bottom surface of layer 510-1 and the right end of the top surface of piezoelectric element 510. This wrap-around electrode arrangement is ideal for connecting piezoelectric electrodes, both + and −, at bottom or top surface for surface mount. However, the wrap-around electrode is not ideal for effective actuation, due to an inherent limitation of current multi-layer piezoelectric element manufacturing technique(s). As such, there is no electrical field at each end “dead zone” due to the same electrode polarity between the top and bottom surfaces of each layer. By contrast, an E field across the whole length of the piezoelectric element, without any dead zones, is considered more ideal. In the case of this example piezoelectric element 510 having a 0.8 mm (millimeter) total length, the effective active length is about 74.2% of the actual length.

For HDD microactuator applications, the multi-layer piezoelectric that is used is typically very short, e.g., around 1.0 mm. Thus, a small reduction in length will lead to a much larger active length reduction, as multi-layer piezoelectrics generally include the dead zones at the two ends in the length direction, to connect electrodes between outer and inner electrodes. Shortening the multi-layer piezoelectric may lose too much actuator stroke, which is not desired. FIG. 5B is a side cross-sectional diagram illustrating a 3-layer piezoelectric element of reduced length, according to an embodiment. A 3-layer piezoelectric element 520 is depicted, with layer 520-1 having polarity in down direction, layer 520-2 having polarity in up direction, and layer 520-3 having polarity in down direction, each respectively depicted with arrows. piezoelectric element 520 further comprises a positive top electrode 521 extending from the top surface of piezoelectric element 520 and wrapping around the end (left side) to the bottom surface of piezoelectric element 520, and a negative bottom electrode 522 extending from the bottom surface of piezoelectric element 520 and wrapping around the end (right side) to the top surface of piezoelectric element 520. In the case of this example reduced-length piezoelectric element 520 having a reduced 0.5 mm (millimeter) total length, the effective active length is about 58.6% of the actual length assuming the same manufacturing constraints (e.g., end zone tolerance capabilities). The stroke reduction can be partially compensated for by reducing layer thickness and adding more layers to the multi-layer piezoelectric design. However, this may not be desired due to other constraints, such as reduced piezoelectric reliability with thinner layers (e.g., higher E field applied) or higher cost with more layers to the piezoelectric element. Furthermore, there is also a manufacturing/cost limit for the lower end of the layer thickness, which limits the range of design flexibility/compensation.

### Miniaturized Single-layer Piezoelectric Elements for Fine Actuator

To reduce piezoelectric length for better microactuator dynamics, a single-layer piezoelectric is utilized instead of using a multi-layer piezoelectric, according to an embodiment. Based on the comparison of piezoelectric element 510 (FIG. 5A) and reduced-length piezoelectric element 520 (FIG. 5B), a reduced-length multi-layer piezoelectric is not an effective use of the piezoelectric material for actuation. According to embodiments, a single-layer piezoelectric, such as with approximately the same total thickness as the 3-layer piezoelectric (i.e., approximately three times the layer thickness) for example, is a better solution. For a single-layer piezoelectric, the active length is at 100% due to no end dead zones. Additionally, a higher AC voltage (e.g., 3x in this comparison example) can be applied to the piezoelectric to induce the same electrical field in the piezoelectric material for stroke generation, without the depolarization concern, while delivering higher total stroke capability within the same design space (Length x Width x Thickness). The combined effect enables a shorter (e.g., 0.5 mm) single-layer piezoelectric to generate more stroke than the 3-layer piezoelectric of the same length. Furthermore, according to an embodiment, the piezoelectric driver circuit can be simplified by removing the DC bias approach for multi- layer piezoelectrics, thereby reducing circuit cost and/or piezoelectric electrical connection traces and complexity. Use of a single-layer piezoelectric element may also be beneficial in that additional material selection with stronger piezoelectric effect for more stroke generation is available than with a multi-layer piezoelectric element design. For example, a single crystal piezoelectric material may be used, such as materials known as PIN-PMN-PT (e.g., a lead indium niobate-lead magnesium niobate-lead titanate) and PMN-PT (e.g., a lead magnesium niobate-lead titanate), which is considered very challenging to implement cost effectively in the context of a multi-layer piezoelectric element configuration. Thus, the term “piezoelectric element” or the like as used herein is intended to include all such elements composed of, or being made from, any piezoelectric material suitable for the described purpose.

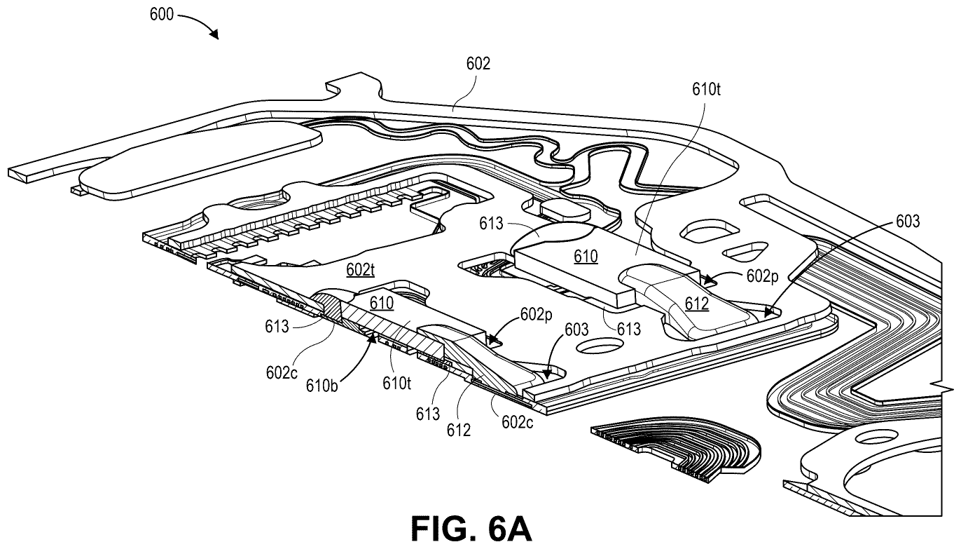

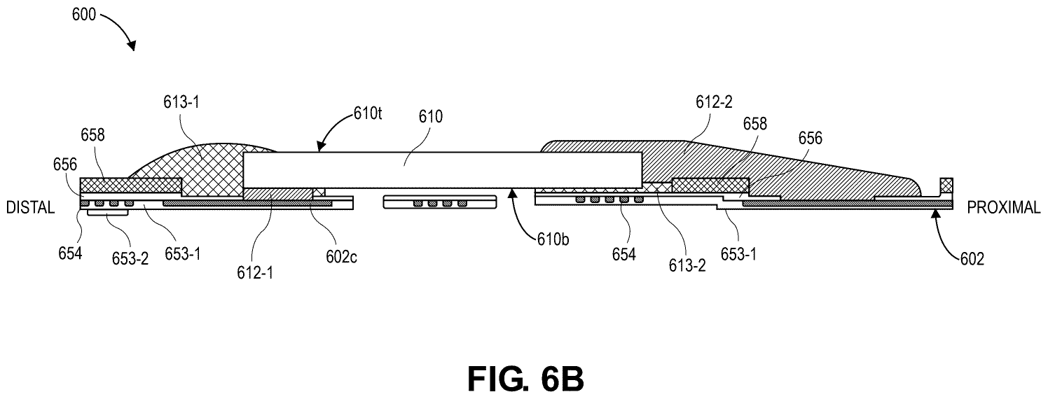

FIG. 6A is a perspective view illustrating a suspension microactuator assembly with single-layer piezoelectric elements, including a cross-section of a piezoelectric element and installation, and FIG. 6B is a cross-sectional side view illustrating the suspension microactuator assembly with single-layer piezoelectric elements of FIG. 6A, both according to an embodiment. Suspension assembly 600 includes a flexure 602 movably coupled with a load beam (not shown here; see, e.g., load beam 110d of FIG. 1, load beam 208b of FIG. 2, load beam 304 of FIG. 3). The suspension assembly 600, particularly the flexure 602, includes a tongue 602t area on which a head slider (not shown here; see, e.g., slider 110b of FIG. 1, slider 306 of FIG. 3) is mounted from the bottom side of the suspension tongue. Suspension assembly 600 further includes a set (e.g., two, as shown here) of microactuator single-layer piezoelectric elements 610 and associated features. According to an embodiment, each piezoelectric element 610 is a single-layer piezoelectric element, with each piezoelectric element 610 comprising a continuous bottom electrode 610b spanning a substantially entire length of a bottom surface of the piezoelectric element 610 and a continuous top electrode 610t spanning a substantially entire length of a top surface of the piezoelectric element 610. Thus, the single-layer piezoelectric elements 610 do not have the end dead zones associated with the multi-layer piezoelectric elements described elsewhere herein and, consequently, have an effective 100% active length. While the single-layer piezoelectric element 610 may have a lower stroke sensitivity (e.g., nm/V, or nanometers per volt) than a multi-layer piezoelectric element 410 (FIG. 4) due to an increased piezoelectric layer thickness, a higher voltage can be applied to generate an equivalent or greater total stroke (nm) while maintaining lifetime reliability of the piezoelectric element 610.

According to an embodiment, flexure 602 is constructed as a multi-layer laminate assembly, comprising at least one conductive layer(s) 654 (e.g., copper circuitry), one or more insulating/cover layer(s) 656, 653-1, 653-2 (e.g., polyimide (“PI”) polymer), and at least one metal structural layer(s) 658 (e.g., stainless steel). The microactuator system comprising the set of piezoelectric elements 610 is mechanically configured to directly move the flexure tongue 602t to move the head slider mounted thereto. Electrical voltage is applied to each piezoelectric element 610 to drive the microactuator, thereby causing the piezoelectric material to expand or contract accordingly. For example, one piezoelectric element 610 is caused to expand while the other piezoelectric element 610 is caused to contract, thereby rotating the flexure tongue 602t and the corresponding head slider attached to the flexure tongue 602t. According to an embodiment, each single-layer piezoelectric element 610 coupled with the flexure tongue 602t is recessed in a pocket 602p in the flexure tongue 602t. According to a related embodiment, each piezoelectric element 610 is recessed in a respective pocket 602p in the flexure tongue 602t.

As depicted in FIG. 6A, and according to an embodiment, pocket 602p is formed in the metal layer of the flexure tongue. For example, a pocket 602p may be etched from the (top) stainless steel layer of the flexure tongue 602t. This structural arrangement for mounting a single-layer piezoelectric element enables the top surface of the piezoelectric element 610 to be more closely aligned, i.e., more in-plane with, the top surface of the flexure 602/flexure tongue 602t. Hence, a more in-plane load transfer from the piezoelectric element 610 to the flexure tongue 602t is provided, thereby providing for better FRF. This recessed mounting arrangement not only minimizes the z-height (e.g., vertical) footprint of the piezoelectric element 610 to thereby minimize any structural interference effects, but also enables a simpler, likely more reliable bridging of the top electrode 610t of the piezoelectric element 610 to the conductive layer 602c via an electrically-conductive adhesive (ECA) 612.

This recessed mounting arrangement of the piezoelectric element 610 within a pocket 602p of the flexure 602 is distinct from how a known milliactuator single-layer piezoelectric element has been mounted. For example, reference is made to FIGS. 9A-9C where FIG. 9A is an exploded perspective view illustrating a suspension milliactuator assembly with single-layer piezoelectric elements, FIG. 9B is a top view illustrating installation of the milliactuator assembly of FIG. 9A, and FIG. 9C is a bottom view illustrating the installation of the milliactuator assembly of FIG. 9A. With this approach to an installation 900 of a milliactuator at an area of a suspension relatively far from the corresponding head slider 906 (e.g., not a collocated fine actuator) and configured to move/rotate the entire front end of the suspension (e.g., load beam 904, flexure 902, and slider 906), each of a base plate 901 and a load beam 904 need to be configured to enable mounting of the slider. As such, pocket features 901p, 904p need to be stamped out (or otherwise fabricated) of the base plate 901 and be etched out of the load beam 904, respectively, to form a shelf for the piezoelectric elements 910 to sit on mechanically. In addition, the flexure 902 needs to have copper pad features at the corresponding locations for piezoelectric elements 910 to terminate electrically. The base plate 901, load beam 904, and flexure 902 are welded together to form a 2-part pocket for the piezoelectric elements 910 to sit on (and bonded structurally via NCA in between), and provide flexure conductive layer/circuit 902c (e.g., copper pads) for the piezoelectric elements' surface electrodes to connect to via ECA, solder, or other means. Therefore, installation of a single-layer piezoelectric element such as microactuator piezoelectric element 610 (FIGS. 6A-6B) into a single-part (e.g., flexure tongue 602t of FIG. 6A) pocket 602p (FIG. 6A) enables a simpler, less costly, and ultimately more accurate (no multiple parts alignment tolerance) and effective mounting and electrode terminating arrangement than the installation of the milliactuator piezoelectric element 910 of FIG. 9A-9C.

With reference now back to FIG. 6B, according to an embodiment, the bottom electrode 610b of piezoelectric is electrically connected with the conductive layer 602c of the flexure via ECA 612-1 at one end (e.g., hinge or distal end) of the piezoelectric element 610. At the other end (e.g., fixed or proximal end) of the piezoelectric element 610, NCA 613-2 is used to bond the piezoelectric element 610 to the flexure 602 structurally and also to insulate the piezoelectric element 610 bottom electrode 610b from ECA 612-2, which is in connection with the piezoelectric element 610 top electrode 610t. The top electrode 610t of piezoelectric element 610 is electrically connected with the underlying conductive layer 602c of the flexure 602 at a proximal end of the piezoelectric element 610 using ECA 612. According to an embodiment, and as depicted in FIGS. 6A-6B, the top electrode 610t is electrically connected with the conductive layer 602c of the flexure tongue 602t beneath an opening 603 in a metal layer 658 and an opening in a PI layer 656 of the flexure tongue 602t. For example, opening 603 may be etched from the top metal layer 658 (e.g., stainless steel (SST) layer) of the flexure tongue 602t and, furthermore, the non-conductive PI layer 656 between the metal layer 658 and conductive layer 654 may be also etched to expose the conductive layer 654, so that electrical connectivity between the top electrode 610t of piezoelectric element 610 and the underlying conductive layer 602c of the flexure 602 is readily enabled with ECA 612-2 for piezoelectric ground termination. Note that ECA 612-2 is also in contact with the metal layer 658, which is viable as it is intended for ground termination. However, SST-to-ECA contact surface is not a reliable circuit connection and thus ECA 612-2 is extended to the underlying conductive layer 602c. According to an embodiment, NCA 613-1 is configured to fill a gap between the piezoelectric element 610 and the metal layer 658 of the flexure tongue 602t, thus providing for better piezoelectric-to-flexure tongue load transfer effectiveness (e.g., via a butt and shear joint, effectively). This structural arrangement for mounting and electrically connecting a single-layer piezoelectric element is distinct from how milliactuator piezoelectric elements 910 are mounted and connected, as described in reference to FIG. 9A-9C. According to a related embodiment, the opening 603 in the metal layer is separate from the pocket 602p in which the piezoelectric element 610 is recessed, and the ECA 612 is configured to bridge a gap separating the pocket 602p and the opening 603.

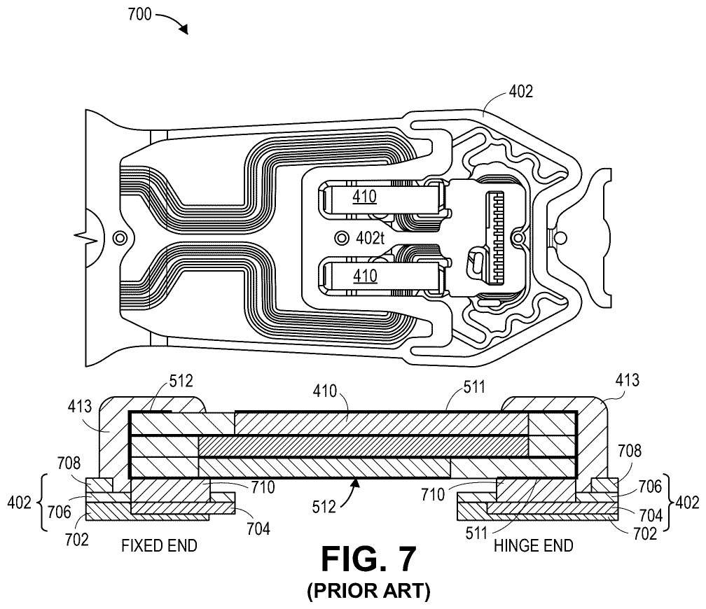

FIG. 7 includes top and cross-sectional side views illustrating installation of a 3-layer piezoelectric element onto a suspension flexure. With the top view (top image), installation 700 depicts the two microactuator 3-layer piezoelectric elements 410 coupled with the flexure tongue 402t of flexure 402. With the side view (bottom image), depicted are layers of the flexure 402 laminate comprising cover layer 702 (e.g., PI), conductive layer 704 (e.g., copper), insulative layer 706 (e.g., PI), and metal layer 708 (e.g., steel, stainless steel). At the fixed end, installation 700 further comprises NCA 413 mechanically connecting piezoelectric element 410 to flexure 402 and ECA 710 electrically connecting the bottom electrode 512 of piezoelectric element 410 to the conductive layer 704 through the PI layer 706 and metal layer 708 of the flexure 402. At the hinge end, installation 700 further comprises NCA 413 mechanically connecting piezoelectric element 410 to flexure 402 and ECA 710 electrically connecting the top electrode 511 of piezoelectric element 410 to the conductive layer 704 through the PI layer 706 and metal layer 708 of the flexure 402.

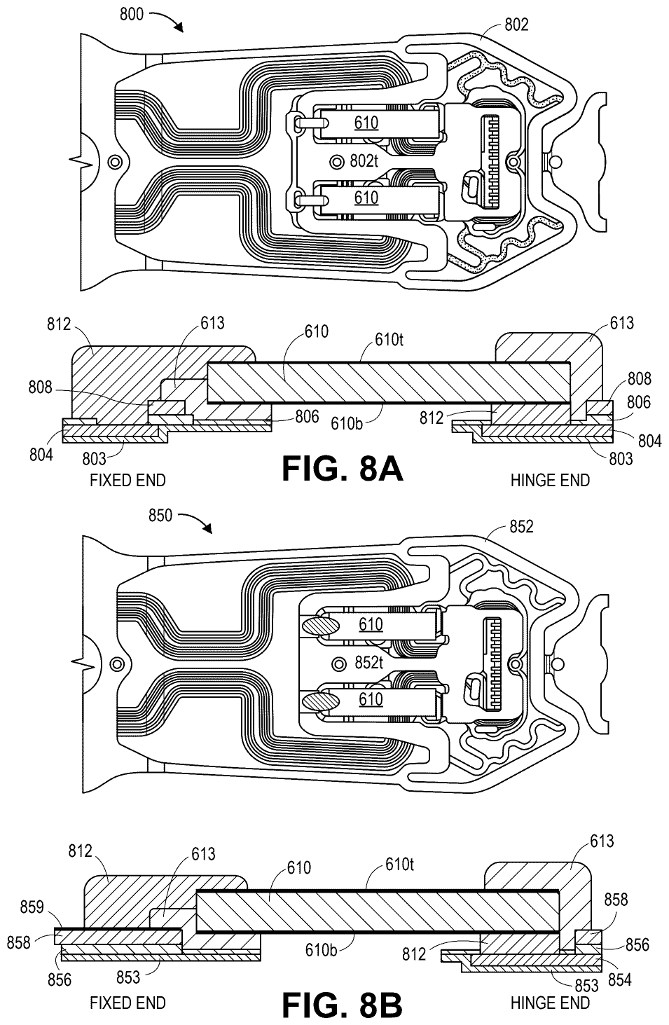

Implementation of a single-layer piezoelectric element (e.g., piezoelectric element 610) rather than a multi-layer piezoelectric element (e.g., piezoelectric element 410) enables options for the installation of the single-layer piezoelectric element, as follows. FIG. 8A includes top and cross-sectional side views illustrating installation of a single-layer piezoelectric element onto a suspension flexure, according to an embodiment. With the top view (top image), installation 800 depicts the two microactuator single-layer piezoelectric elements 610 coupled with the flexure tongue 802t of flexure 802. With the side view (bottom image), depicted are layers of the flexure 802 laminate (layer thicknesses not necessarily to scale) comprising cover layer 803 (e.g., PI), conductive layer 804 (e.g., copper; see also, e.g., conductive layer 602c of FIGS. 6A-6B), insulative layer 806 (e.g., PI), and metal layer 808 (e.g., steel, stainless steel). At the fixed end, installation 800 further comprises NCA 613 mechanically connecting piezoelectric element 610 to flexure 802 and ECA 812 electrically connecting the top electrode 610t of piezoelectric element 610 to the conductive layer 804 through the PI layer 806 and metal layer 808 of the flexure 802. The conductive layer 804 at the fixed end is connected to ground for piezoelectric top electrode termination. At the hinge end, installation 800 further comprises NCA 613 mechanically connecting piezoelectric element 610 to flexure 802 and ECA 812 electrically connecting the bottom electrode 610b of piezoelectric element 610 to the conductive layer 804 through the PI layer 806 and metal layer 808 of the flexure 802. The conductive layer 804 at the hinge end is connected to a piezoelectric driver to provide control voltage, which will form an electrical field in piezoelectric between piezoelectric bottom and top piezoelectric electrodes, for operating the piezoelectric.

FIG. 8B includes top and cross-sectional side views illustrating installation of a single-layer piezoelectric element onto a suspension flexure, according to an embodiment. At top view (top image), installation 850 depicts the two microactuator single-layer piezoelectric elements 610 coupled with the flexure tongue 852t of flexure 852. With the side view (bottom image), depicted are layers of the flexure 852 laminate (layer thicknesses not necessarily to scale) comprising cover layer 853 (e.g., PI), conductive layer 854 (e.g., copper; see also, e.g., conductive layer 602c of FIGS. 6A-6B), insulative layer 856 (e.g., PI), and metal layer 858 (e.g., steel, stainless steel). At the fixed end, installation 850 further comprises NCA 613 mechanically connecting piezoelectric element 610 to flexure 852 and ECA 812 electrically connecting the top electrode 610t of piezoelectric element 610 to a gold plating 859 plated onto the metal layer 858 of the flexure 852. The gold plating 859 on the metal layer 858 is to ensure reliable electrical connection between top piezoelectric electrode 610t and the metal layer 858 through ECA 812. At the hinge end, installation 850 further comprises NCA 613 mechanically connecting piezoelectric element 610 to flexure 852 and ECA 812 electrically connecting the bottom electrode 610b of piezoelectric element 610 to the conductive layer 854 through the PI layer 856 and metal layer 858 of the flexure 852. Here, grounding is achieved by electrically connecting the top electrode 610t of piezoelectric element 610 at the fixed (leading) end to a gold plating 859 on the metal layer 858, which provide a simpler, more easily-fabricated ground path.

### Method of Manufacturing a Hard Disk Drive Microactuator Assembly

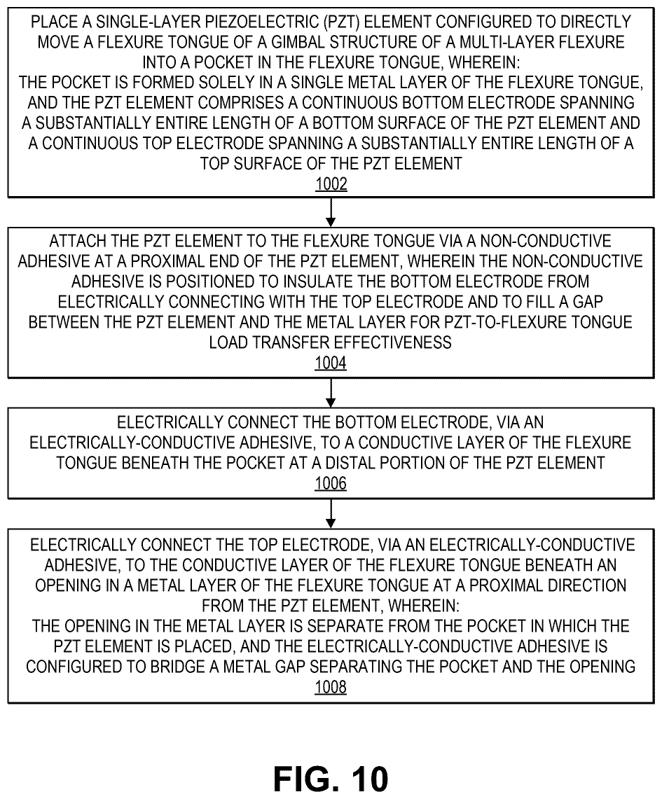

FIG. 10 is a flow diagram illustrating a method of manufacturing a HDD microactuator system, according to an embodiment. An HDD microactuator assembly, such as a fine actuator system configured to move (e.g., rotate) only the slider (e.g., moving it relative to the suspension and load beam), assembled, manufactured, and/or produced according to the method of FIG. 10 is designed, configured, intended for implementation into a hard disk drive (HDD) (see, e.g., HDD 100 of FIG. 1).

At block 1002, place a single-layer piezoelectric element configured to directly move a flexure tongue of a gimbal structure of a multi-layer flexure into a pocket in the flexure tongue. According to an embodiment, the pocket is formed in the metal layer of the flexure tongue, and the piezoelectric element comprises a continuous bottom electrode spanning a substantially entire length of a bottom surface of the piezoelectric element and a continuous top electrode spanning a substantially entire length of a top surface of the piezoelectric element. For example, a single-layer piezoelectric element 610 (FIGS. 6A-6B) configured to directly move a flexure tongue 602t (FIG. 6A) of a gimbal structure of a multi-layer flexure 602 (FIGS. 6A-6B) is placed into a pocket 602p (FIG. 6A) in the flexure tongue 602t.

At block 1004, attach the piezoelectric element to the flexure tongue via a non-conductive adhesive at a proximal end of the piezoelectric element. According to an embodiment, the non-conductive adhesive is positioned to insulate the bottom electrode from electrically connecting with the top electrode and to fill a gap between the piezoelectric element and the metal layer for piezoelectric-to-flexure tongue load transfer effectiveness. For example, piezoelectric element 610 is attached to the flexure tongue 602t via a non-conductive adhesive (NCA) 613-2 (FIG. 6B) at a proximal end of the piezoelectric element 610, where the NCA 613-2 is positioned to insulate the bottom electrode 610b (FIGS. 6A-6B) from electrically connecting with the top electrode 610t (FIGS. 6A-6B) and to fill a gap between the piezoelectric element 610 and the metal layer 658 (see also, e.g., 808 of FIG. 8A, 858 of FIG. 8B) at both distal and proximal ends for piezoelectric-to-flexure tongue load transfer effectiveness.

At block 1006, electrically connect the bottom electrode, via an electrically-conductive adhesive, to a conductive layer of the flexure tongue beneath the pocket at a distal portion of the piezoelectric element. For example, the bottom electrode 610b is electrically connected, via an electrically-conductive adhesive 612-1 (FIG. 6B), to a conductive layer 602c (FIGS. 6A-6B) of the flexure tongue 602t beneath the pocket 602p at a distal portion of the piezoelectric element 610.

At block 1008, electrically connect the top electrode, via an electrically-conductive adhesive, to the conductive layer of the flexure tongue beneath an opening in a metal layer of the flexure tongue at a proximal direction from the piezoelectric element. According to an embodiment, the opening in the metal layer is separate from the pocket in which the piezoelectric element is placed, and the electrically-conductive adhesive is configured to bridge a metal gap separating the pocket and the opening. For example, the top electrode 610t is electrically connected, via an electrically-conductive adhesive 612-2 (FIG. 6B), to the conductive layer 602c of the flexure tongue 602t beneath an opening 603 (FIG. 6A) in a metal layer of the flexure tongue 602t at a proximal direction from the piezoelectric element 610.

In view of the embodiments described herein, implementation of single-layer piezoelectric elements in a hard disk drive microactuator system, in comparison to multi-layer piezoelectric elements, can improve TMR capability (e.g., better FRF), reduce piezoelectric unit cost (e.g., piezoelectric manufacturing process is simpler with single layer piezoelectric with no electrode alignment requirement), and reduce piezoelectric circuit cost and complexity (e.g., the piezoelectric driving signal can be simplified without DC bias, and a single signal trace can be employed for connecting two piezoelectric elements (where the two piezoelectric are polarized in opposite directions) with a higher AC voltage to achieve the same stroke).

### Physical Description of an Illustrative Operating Context

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134, and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are transmitted by a flexible cable assembly (FCA) 156 (or “flex cable”, or “flexible printed circuit” (FPC)). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (or “enclosure base” or “baseplate” or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM, and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management, and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

What is claimed is:

1. A hard disk drive (HDD) suspension assembly comprising:
a load beam;
a multi-layer flexure coupled with the load beam, the flexure comprising a gimbal structure comprising a flexure tongue to which a head slider is mounted; and
a microactuator mechanically configured to directly move the flexure tongue to move the head slider mounted thereto, the microactuator comprising:
single-layer piezoelectric elements coupled with the flexure tongue and each recessed in a pocket in the flexure tongue, and
wherein each piezoelectric element comprises a continuous bottom electrode spanning a substantially entire length of a bottom surface of the piezoelectric element and a continuous top electrode spanning a substantially entire length of a top surface of the piezoelectric element.

2. The HDD suspension assembly of claim 1, wherein each piezoelectric element is coupled with the flexure tongue via a non-conductive adhesive, at a proximal end of the piezoelectric element, configured to insulate the bottom electrode from electrically connecting with the top electrode.

3. The HDD suspension assembly of claim 2, wherein the non-conductive adhesive is further configured to fill a gap between the piezoelectric element and a metal layer of the flexure tongue for piezoelectric-to-flexure tongue load transfer effectiveness.

4. The HDD suspension assembly of claim 2, wherein the bottom electrode is electrically connected with a conductive layer of the flexure tongue beneath the pocket at the distal end of the piezoelectric element.

5. The HDD suspension assembly of claim 4, wherein the top electrode is electrically connected, via an electrically-conductive adhesive at a proximal end of the piezoelectric element, with the conductive layer of the flexure tongue.

6. The HDD suspension assembly of claim 1, wherein the pocket is formed in a metal layer of the flexure tongue.

7. The HDD suspension assembly of claim 6, wherein each piezoelectric element is recessed in a respective pocket in the flexure tongue.

8. The HDD suspension assembly of claim 1, wherein the top electrode is electrically connected, via an electrically-conductive adhesive at a proximal end of the piezoelectric element, with a conductive layer of the flexure tongue beneath an opening in a metal layer of the flexure tongue.

9. The HDD suspension assembly of claim 8, wherein:
the opening in the metal layer is separate from the pocket in which the piezoelectric element is recessed; and
the electrically-conductive adhesive is configured to bridge a metal gap separating the pocket and the opening.

10. A hard disk drive comprising the HDD suspension assembly of claim 9.

11. The HDD suspension assembly of claim 1, wherein the top electrode is electrically connected to ground via an electrically-conductive adhesive at a proximal end of the piezoelectric element to a gold plating on a top surface of a metal layer of the flexure tongue.

12. The HDD suspension assembly of claim 1, wherein each piezoelectric element is composed of at least one from a group of materials consisting of PZT, PMN-PT, and PIN-PMN-PT.

13. A hard disk drive (HDD) comprising:
disk media rotatably mounted on a spindle;
a plurality of head sliders, each head slider housing a read-write transducer configured to read from and to write to a disk medium of the disk media;
means for moving the plurality of head sliders to access portions of the disk media; and
suspension assemblies coupled with the means for moving, each suspension assembly comprising:
a multi-layer flexure comprising a gimbal structure comprising a flexure tongue to which a head slider of the plurality of head sliders is mounted, and
a microactuator system mechanically configured to directly move the flexure tongue to move the head slider mounted thereto, the microactuator system comprising:
single-layer piezoelectric elements coupled with the flexure tongue and each recessed in a pocket in the flexure tongue, and
wherein each piezoelectric element comprises a continuous bottom electrode spanning a substantially entire length of a bottom surface of the piezoelectric element and a continuous top electrode spanning a substantially entire length of a top surface of the piezoelectric element.

14. The HDD of claim 13, wherein:
each piezoelectric element is coupled with the flexure tongue via a non-conductive adhesive at a proximal end of the piezoelectric element; and
the non-conductive adhesive is configured to:
insulate the bottom electrode from electrically connecting with the top electrode, and
fill a gap between the piezoelectric element and a metal layer of the flexure tongue for piezoelectric-to-flexure tongue load transfer effectiveness.

15. The HDD of claim 14, wherein:
the bottom electrode is electrically connected with a conductive layer of the flexure tongue beneath the pocket at the distal end of the piezoelectric element; and
the top electrode is electrically connected, via an electrically-conductive adhesive at a proximal end of the piezoelectric element, with the conductive layer of the flexure tongue.

16. The HDD of claim 13, wherein the top electrode is electrically connected with, via an electrically-conductive adhesive at a proximal end of the piezoelectric element, a conductive layer of the flexure tongue beneath an opening in a metal layer of the flexure tongue.

17. The HDD of claim 16, wherein:
the opening in the metal layer is separate from the pocket in which the piezoelectric element is recessed; and
the electrically-conductive adhesive is configured to bridge a metal gap separating the pocket and the opening.

18. The HDD of claim 13, further comprising:
electronic controller circuitry configured to operate each piezoelectric element with an alternating-current (AC) voltage and without a direct-current (DC) bias voltage.

19. The HDD of claim 13, wherein the top electrode is electrically connected to ground via an electrically-conductive adhesive at a proximal end of the piezoelectric element to a gold plating on a top surface of a metal layer of the flexure tongue.

20. A method of manufacturing a hard disk drive (HDD) microactuator system, the method comprising:
placing a single-layer piezoelectric element, configured to directly move a flexure tongue of a gimbal structure of a multi-layer flexure, into a pocket in the flexure tongue, wherein:
the pocket is formed in the metal layer of the flexure tongue, and
the piezoelectric element comprises a continuous bottom electrode spanning a substantially entire length of a bottom surface of the piezoelectric element and a continuous top electrode spanning a substantially entire length of a top surface of the piezoelectric element;
attaching the piezoelectric element to the flexure tongue via a non-conductive adhesive at a proximal end of the piezoelectric element, wherein the non-conductive adhesive is positioned to insulate the bottom electrode from electrically connecting with the top electrode and to fill a gap between the piezoelectric element and the metal layer for piezoelectric-to-flexure tongue load transfer effectiveness;
electrically connecting the bottom electrode, via an electrically-conductive adhesive, to a conductive layer of the flexure tongue beneath the pocket at a distal portion of the piezoelectric element; and
electrically connecting the top electrode, via an electrically-conductive adhesive, to the conductive layer of the flexure tongue beneath an opening in a metal layer of the flexure tongue at a proximal direction from the piezoelectric element, wherein:
the opening in the metal layer is separate from the pocket in which the piezoelectric element is placed, and
the electrically-conductive adhesive is configured to bridge a metal gap separating the pocket and the opening.
